(19) United States
(12) Patent Application Publication
(10) Pub. No.: US 2018/0164630 A1
(43) Pub. Date: Jun. 14, 2018

(54) LIQUID CRYSTAL CELL AND THREE-DIMENSIONAL STRUCTURAL LIQUID CRYSTAL CELL

(71) Applicant: FUJIFILM Corporation, Tokyo (JP)

(72) Inventor: Junichi HIRAKATA, Minami-ashigara-shi (JP)

(73) Assignee: FUJIFILM Corporation, Tokyo (JP)

(21) Appl. No.: 15/893,162

(22) Filed: Feb. 9, 2018

Related U.S. Application Data
(63) Continuation of application No. PCT/JP2016/075344, filed on Aug. 30, 2016.

(30) Foreign Application Priority Data
Aug. 31, 2015 (JP) 2015-170248

(51) Int. Cl. G02F 1/1333; B32B 27/36; B32B 27/30; B32B 27/08; C08F 20/28

(52) U.S. Cl. CPC G02F 1/133345; B32B 27/365; B32B 27/308; B32B 27/08; G02F 2202/025; C08F 20/28; B32B 2307/728; B32B 2457/202; G02F 1/133305

(57) ABSTRACT

An object of the invention is to provide a liquid crystal cell in which liquid crystal molecules do not permeate into a plastic substrate even in a case where the plastic substrate is largely deformed as it is stretched or contracted, and a three-dimensional structural liquid crystal cell using the liquid crystal cell. A liquid crystal cell according to the invention includes at least two plastic substrates and a liquid crystal layer, at least one plastic substrate is a heat-shrinkable film satisfying a heat shrinkage rate of 5% to 75%, a polymer layer which is obtained by polymerizing a composition including a monofunctional (meth)acrylate having a hydrophilic group between at least one plastic substrate and the liquid crystal layer is further included, and an absorption maximum wavelength the monofunctional (meth)acrylate is 190 to 250 nm.

### CROSS-REFERENCE TO RELATED APPLICATIONS

This application is a Continuation of PCT International Application No. PCT/JP2016/075344 filed on Aug. 30, 2016, which claims priority under 35 U.S.C. § 119(a) to Japanese Patent Application No. 2015-170248 filed on Aug. 31, 2015. The above application is hereby expressly incorporated by reference, in its entirety, into the present application.

### BACKGROUND OF THE INVENTION

### 1. Field of the Invention

The present invention relates to a liquid crystal cell using a plastic substrate and a three-dimensional structural liquid crystal cell using the liquid crystal cell.

### 2. Description of the Related Art

In recent years, various plastic substrates have been considered as a replacement for a glass substrate of a device such as a liquid crystal display element.

Plastic substrates are inferior in the gas barrier property for shielding oxygen and water vapor to glass substrates. Accordingly, a gas barrier layer for sealing has been known to be used in combination.

As such a gas barrier layer, a gas barrier film having an organic layer and an inorganic layer is considered (for example, JP2011-51220A).

### SUMMARY OF THE INVENTION

In a case where a plastic substrate is used, it can be used in a flexible display or the like which has attracted attention in recent years. However, the level of flexibility required for a liquid crystal cell has been increased, and it has been found that in a case where a curved surface having a higher curvature is formed by elongation, contraction, bending, or the like, a problem may occur in that liquid crystal molecules permeate into the plastic substrate and display performance is impaired due to clouding.

The gas barrier layer achieves a certain effect in preventing liquid crystal molecules from permeating into the plastic substrate. However, since the gas barrier layer is a laminate of an organic layer and an inorganic layer, it is found that the inorganic layer cannot follow the expanding and contraction in a case where a curved surface is formed, and cracks occur.

An object of the invention is to provide a liquid crystal cell which suppresses permeation of liquid crystal molecules into a plastic substrate even in a case where the plastic substrate is largely deformed as it is stretched or contracted, and a three-dimensional structural liquid crystal cell using the liquid crystal cell.

The inventors have conducted intensive studies, and found that in a case where a specific polymer layer is provided between a plastic substrate and a liquid crystal layer in a liquid crystal cell, liquid crystal molecules do not permeate into the plastic substrate even in a case where the plastic substrate is largely deformed, and thus it is possible to prevent a reduction in the display performance as the liquid crystal cell.

That is, the inventors have found that the object can be achieved with the following configuration.

[1] A liquid crystal cell comprising: at least two plastic substrates; and a liquid crystal layer; in which at least one plastic substrate is a heat-shrinkable film satisfying a heat shrinkage rate of 5% to 75%, a polymer layer which is obtained by polymerizing a composition including at least one kind of monofunctional monomer having a hydrophilic group and selected from the group consisting of a monofunctional acrylate and a monofunctional methacrylate between at least one plastic substrate and the liquid crystal layer is further included, and an absorption maximum wavelength of the monofunctional monomer is 190 to 250 nm.

[2] The liquid crystal cell according to [1], in which the composition including a monofunctional monomer is a composition exhibiting one or both of a thermosetting property and ultraviolet curability.

[3] The liquid crystal cell according to [1] or [2], in which the monofunctional monomer is a monofunctional monomer having two or more hydrophilic groups.

[4] The liquid crystal cell according to any one of [1] to [3], in which the hydrophilic group is a nonionic hydrophilic group.

[5] The liquid crystal cell according to [4], in which the nonionic hydrophilic group is at least one kind of hydrophilic group selected from the group consisting of a hydroxyl group, a substituted or unsubstituted amino group, and a polyethylene glycol group.

[6] The liquid crystal cell according to any one of [1] to [5], in which the monofunctional monomer is a monofunctional monomer having two or more hydroxyl groups as a hydrophilic group.

[7] The liquid crystal cell according to any one of [1] to [5], in which the monofunctional monomer is a monofunctional monomer having both of a hydroxyl group and a substituted or unsubstituted amino group as a hydrophilic group.

[8] The liquid crystal cell according to any one of [1] to [7], in which the monofunctional monomer has an SP value of 22 to 40.

[9] The liquid crystal cell according to any one of [1] to [8], in which all the plastic substrates are heat-shrinkable films satisfying a heat shrinkage rate of 5% to 75%.

[10] The liquid crystal cell according to any one of [1] to [9], in which at least one plastic substrate is a thermoplastic resin film stretched by greater than 0% and not greater than 300%.

[11] A three-dimensional structural liquid crystal cell which is formed by changing dimensions of the liquid crystal cell according to any one of [1] to [10] by ±5% to 75%.

According to the invention, it is possible to provide a liquid crystal cell in which liquid crystal molecules do not permeate into a plastic substrate even in a case where the plastic substrate is largely deformed as it is stretched or contracted, and a three-dimensional structural liquid crystal cell using the liquid crystal cell.

### BRIEF DESCRIPTION OF THE DRAWING

FIG. 1 is a cross-sectional view schematically illustrating an aspect of a liquid crystal cell according to the invention.

### DESCRIPTION OF THE PREFERRED EMBODIMENTS

Hereinafter, the invention will be described in detail.

The following description of constituent requirements is based on typical embodiments of the invention, but the invention is not limited thereto.

In this specification, a numerical value range expressed using “to” means a range including numerical values before and after “to” as a lower limit value and an upper limit value.

In this specification, parallel or perpendicular does not mean parallel or perpendicular in a strict sense, but means a range of having ±5° from parallel or perpendicular.

In the invention, “(meth)acrylate” represents any one or both of acrylate and methacrylate, “(meth)acrylic” represents any one or both of acrylic and methacrylic, and “(meth)acryloyl” represents any one or both of acryloyl and methacryloyl.

In the invention, “monomer” is synonymous with “monomer”. In this specification, a monomer is a compound which is distinguished from an oligomer and a polymer and has a weight average molecular weight of 2,000 or less.

In the invention, a polymerizable compound is a compound having a polymerizable functional group, and may be a monomer or a polymer. The polymerizable functional group is a group related to a polymerization reaction.

<Liquid Crystal Cell>

A liquid crystal cell according to the invention has at least two plastic substrates and a liquid crystal layer, and further has, between at least one plastic substrate and the liquid crystal layer, a polymer layer obtained by polymerizing a composition including at least one kind of monofunctional monomer having a hydrophilic group and selected from the group consisting of a monofunctional acrylate and a monofunctional methacrylate (hereinafter, also referred to as “hydrophilic group-containing monofunctional (meth)acrylate”).

In the liquid crystal cell according to the invention, at least one plastic substrate is a heat-shrinkable film satisfying a heat shrinkage rate of 5% to 75%.

In the liquid crystal cell according to the invention, the absorption maximum wavelength of the hydrophilic group-containing monofunctional (meth)acrylate is 190 to 250 nm.

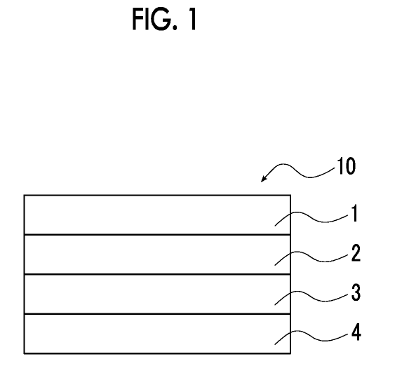

FIG. 1 schematically illustrates a cross-sectional view of a liquid crystal cell according to the invention.

A liquid crystal cell 10 illustrated in FIG. 1 has two plastic substrates 1 and 4 and a liquid crystal layer 3, and further has, between the plastic substrate 1 and the liquid crystal layer 3, a polymer layer 2 which is obtained by polymerizing a composition including a hydrophilic group-containing monofunctional (meth)acrylate.

In the liquid crystal cell 10 illustrated in FIG. 1, at least one plastic substrate is a heat-shrinkable film satisfying a heat shrinkage rate of 5% to 75%, and the absorption maximum wavelength of the hydrophilic group-containing monofunctional (meth)acrylate is 190 to 250 nm.

In the invention, a liquid crystal cell includes a liquid crystal cell which is used in a liquid crystal display device for use in a thin television, a monitor, a laptop computer, a cell phone, or the like, and a liquid crystal cell which is used in a dimming device which changes the intensity of light to be applied for interior decoration, a building material, a vehicle, or the like. That is, a liquid crystal cell is a generic term for devices in which a liquid crystal material or the like enclosed between two substrates is driven.

In this specification, the terms liquid crystal cell before three-dimensional forming and three-dimensional structural liquid crystal cell after three-dimensional forming may be separately used.

A liquid crystal cell according to the invention, that is, a liquid crystal cell which has a heat-shrinkable film satisfying a heat shrinkage rate of 5% to 75% as at least one plastic substrate means a liquid crystal cell for forming before heat shrinkage.

Regarding drive modes of the liquid crystal cell, various methods can be used including a horizontal alignment mode (In-Plane-Switching: IPS), a vertical alignment mode (Vertical Alignment: VA), a twisted nematic mode (Twisted Nematic: TN), and a super twisted nematic mode (Super Twisted Nematic: STN).

In the liquid crystal cell according to the invention, a conductive layer for driving a liquid crystal by applying a voltage, an alignment film for putting liquid crystal molecules into a desired alignment state, dye molecules used to change the intensity of light in a dimming element, and the like may be used in combination.

A backlight member, a polarizer member, or the like may be additionally provided or bonded to the outside of the liquid crystal cell in accordance with the configuration of the liquid crystal cell.

[Polymer Layer]

A polymer layer used in the invention is a layer which is obtained by polymerizing a composition including a hydrophilic group-containing monofunctional (meth)acrylate, and is preferably a polymer layer including a repeating unit derived from a compound containing a hydrophilic group and a (meth)acryloyl group.

In a case where a monofunctional (meth)acrylate is used, flexibility can be imparted to the polymer layer formed after thermal or ultraviolet curing. Accordingly, it is possible to follow the deformation of the plastic substrate in a case where the plastic substrate is stretched or contracted.

In the invention, by introducing a hydrophilic group to a monofunctional (meth)acrylate, it is possible to prevent hydrophobic liquid crystal molecules from permeating into the plastic substrate.

Regarding the polymer layer used in the invention, a monofunctional (meth)acrylate having a hydrophilic group may be independently polymerized, or may form a copolymer with another repeating unit. In a case where a copolymer is formed, another repeating unit may be a repeating unit having no hydrophilic group. Examples of another repeating unit include a vinyl group, a styryl group, and an allyl group as a copolymerization unit.

The amount of the hydrophilic group-containing (meth)acrylate monomer in the polymer layer used in the invention is preferably 30 mass % or greater, particularly preferably 50 mass % or greater, and most preferably 70 mass % or greater of a total constituent monomer amount of the polymer layer.

The mass average molecular weight of the polymer in the polymer layer used in the invention is preferably 1,000,000 or less, particularly preferably 500,000 or less, and most preferably 50,000 to 300,000.

The mass average molecular weight can be measured as a value in terms of polystyrene (PS) using gel permeation chromatography (GPC).

{Hydrophilic Group-Containing Monofunctional (Meth)Acrylate}

The hydrophilic group-containing monofunctional (meth)acrylate used in the invention has at least one hydrophilic group, and preferably has two or more hydrophilic groups.

The hydrophilic group used in the invention is preferably a nonionic hydrophilic group in order not to impair the driving performance of the liquid crystal cell.

The nonionic hydrophilic group is particularly preferably at least one kind of hydrophilic group selected from the group consisting of a hydroxyl group, a substituted or unsubstituted amino group, and a polyethylene glycol group, and most preferably a hydroxyl group or a polyethylene glycol group.

In a case where the hydrophilic group-containing monofunctional (meth)acrylate used in the invention has two or more hydrophilic groups, an aspect in which all of the hydrophilic groups are hydroxyl groups, or an aspect in which both of a hydroxyl group and a substituted or unsubstituted amino group are included is preferable.

Specific examples of the hydrophilic group-containing monofunctional (meth)acrylate used in the invention include (meth)acrylic acid esters of polyoxyalkylene glycol, (meth)acrylic acid esters of polyhydric alcohol, (meth)acrylic acid esters of ethylene oxide or propylene oxide adduct, epoxy (meth)acrylates, urethane (meth)acrylates, polyester (meth)acrylates, (meth)acrylamides, (meth)acryloyl morpholines, and (meth)acrylates having a quaternary alkylammonium salt.

The absorption maximum wavelength of the hydrophilic group-containing monofunctional (meth)acrylate used in the invention is 190 to 250 nm, and preferably 190 to 230 nm from the viewpoint of the polymer layer obtained by polymerizing a composition including a monofunctional (meth)acrylate and the transmittance of the entire liquid crystal cell.

<<Absorption Maximum Wavelength>>

In the invention, regarding the absorption maximum wavelength, a transmission spectrum in the range of 190 to 700 nm is measured using a spectrophotometer (UV3150, manufactured by Shimadzu Corporation) in an atmosphere of a relative humidity of 55% at 25° C., and a wavelength at which the light intensity is minimized is obtained.

The SP value of the hydrophilic group-containing monofunctional (meth)acrylate used in the invention is preferably 22 to 40, and more preferably 24 to 28.

<<SP Value>>

In the invention, the SP value (solubility parameter) is a numerical value which is defined by the square root of a cohesive energy density, and indicates an intermolecular force. The SP value is a display method which can quantify the polarity of a polymer or a low-molecular-weight compound such as a solvent, and can be obtained by the following calculation or actual measurement.

SP Value(δ)=(ΔEv/V)^{1/2}

In the above expression, ΔEv represents a mole evaporation energy, and V represents a mole volume.

In the invention, as the SP value, a value calculated through the Hoy method is used.

A commercially available product can also be used as the hydrophilic group-containing monofunctional (meth)acrylate used in the invention. Examples thereof include BLEMMER GLM manufactured by NOF Corporation as (meth)acrylic acid esters of polyhydric alcohol and BLEMMER AE400 as (meth)acrylic acid esters of polyoxyalkylene glycol.

{Method of Forming Polymer Layer}

The polymer layer used in the invention can be formed by applying, drying, or curing a composition including a hydrophilic group-containing monofunctional (meth)acrylate on a plastic substrate in a direct manner or via another layer. Particularly, it is preferable that a polymer layer is installed directly or indirectly on a conductive layer to be described later and an alignment film is further installed on the polymer layer directly or indirectly. The composition may be applied, dried, or cured on a separate support to form a layer, and then the layer may be peeled off and adhered to the plastic substrate via a pressure sensitive adhesive or the like.

[Conductive Layer]

The conductive layer used in the invention is a layer which is disposed on the plastic substrate and has a conductive property.

In the invention, having a conductive property is that the sheet resistance value is 0.1Ω/□ to 10,000Ω/□, and a layer generally called an electric resistance layer is also included.

In a case where the conductive layer is used as an electrode of a flexible display device or the like, the sheet resistance value thereof is preferably low. Specifically, the sheet resistance value is preferably 300Ω/□ or less, particularly preferably 200Ω/□ or less, and most preferably 100 Ω/□.

The conductive layer used in the invention is preferably transparent. In the invention, transparent means that the transmittance is 60% to 99%.

The transmittance of the conductive layer is preferably 75% or greater, particularly preferably 80% or greater, and most preferably 90% or greater.

The heat shrinkage rate of the conductive layer used in the invention is preferably close to a heat shrinkage rate of the plastic substrate. Using such a conductive layer, short circuit in the conductive layer according to the shrinkage of the plastic substrate can be suppressed, or a change in the electric resistivity can be minimized.

Specifically, the heat shrinkage rate of the conductive layer is preferably 50% to 150%, more preferably 80% to 120%, and even more preferably 90% to 110% of the heat shrinkage rate of the plastic substrate.

Examples of the material which can be used for the conductive layer used in the invention include metal oxide (indium tin oxide: ITO and the like), carbon nanotube (carbon nanotube: CNT, carbon nanobud: CNB, and the like), graphene, polymeric conductor (polyacetylene, polypyrrole, polyphenol, polyaniline, PEDOT/PSS, and the like), metal nanowire (silver nanowire, copper nanowire, and the like), and metal mesh (silver mesh, copper mesh, and the like). Regarding a conductive layer of a metal mesh, a layer in which conductive particles such as silver or copper are dispersed in matrix is more preferable than a layer made only of a metal from the viewpoint of the heat shrinkage rate.

A conductive layer in which particles of a metal mesh form, a carbon nanotube form, a metal nanowire, or the like are dispersed in matrix is preferable since it can easily follow the shrinkage of the plastic substrate in a case where the glass transition temperature (Tg) of the matrix is set to be equal to or lower than a temperature at which the plastic substrate shrinks. In addition, the above conductive layer is preferable since the generation of wrinkles can be further suppressed than in a case of a conductive layer using a metal oxide or a polymeric conductor, and thus an increase in the haze can be suppressed.

[Alignment Film]

The alignment film used in the invention is not particularly limited, and is preferably an alignment film using a compound which can achieve the vertical alignment of rod-like liquid crystals. The alignment film particularly preferably contains at least one kind of compound selected from the group consisting of a soluble polyimide, a polyamic acid, a polyamic acid ester, a (meth)acrylic acid copolymer, an alkyl group-containing alkoxysilane, an alkyl group-containing ammonium, and pyridinium, and most preferably contains at least one kind of compound selected from a soluble polyimide, a polyamic acid, and a polyamic acid ester.

<Soluble Polyimide>

The soluble polyimide used in the invention is described in various literatures. Examples thereof include a polyimide described in Plastic LCD's Material Technology and Low Temperature Process, published by Technical Information Institute Co., Ltd., p. 105.

<Polyamic Acid and Polyamic Acid Ester>

The polyamic acid and the polyamic acid ester used in the invention are described in various literatures. Examples thereof include those in JP2014-238564A.

<(Meth)Acrylic Acid Copolymer>

The (meth)acrylic acid copolymer used in the invention is described in various literatures. Examples thereof include those in JP2002-98828A and JP2002-294240A. Particularly preferable is a carbazole group-containing (meth)acrylic acid copolymer.

<Alkyl Group-Containing Alkoxysilane>

The alkyl group-containing alkoxysilane used in the invention is described in various literatures. Examples thereof include those in JP1984-60423A (JP-S59-60423A), JP1987-269119A (JP-S62-269119A), JP1987-269934A (JP-562-269934A), JP1987-270919A (JP-S62-270919A), and WO2012/165354A. Particularly preferable is an alkoxysilane containing a long chain alkyl group with 8 to 18 carbon atoms or an alkyl group substituted by a fluorine atom.

<Alkyl Group-Containing Ammonium>

The alkyl group-containing ammonium used in the invention is described in various literatures. Examples thereof include those in JP2005-196015A. Particularly preferable is an ammonium containing a long chain alkyl group with 8 to 18 carbon atoms or an alkyl group substituted by a fluorine atom.

<Pyridinium>

The pyridinium used in the invention is described in various literatures. Examples thereof include those in JP2005-196015A and JP2005-272422A. Particularly preferable is pyridinium represented by Formula (I) in JP2005-272422A.

<Other Components>

The alignment film composition used in the invention may contain other components if necessary. Examples of other components include polymers other than the above-described polymers, and these can be used to improve solution characteristics or electric characteristics. Examples of other components include polyester, polyamide, a cellulose derivative, polyacetal, a polystyrene derivative, a poly(styrene-phenylmaleimide) derivative, and poly (meth)acrylate. In a case where other polymers are blended in the alignment film composition, the blending ratio is preferably 20 parts by mass or less, and particularly preferably 10 parts by mass with respect to total 100 parts by mass of the polymer components in the alignment film composition.

<Solvent>

The alignment film composition used in the invention is prepared as a liquid-like composition in which the above-described polymer and other components which are used if necessary are preferably dispersed or dissolved in an appropriate solvent.

Examples of an organic solvent to be used include N-methyl-2-pyrrolidone, γ-butyrolactone, γ-butyrolactam, N,N-dimethylformamide, N,N-dimethylacetamide, 4-hydroxy-4-methyl-2-pentanone, ethylene glycol monomethyl ether, butyl lactate, butyl acetate, methyl methoxy propionate, ethyl ethoxy propionate, ethylene glycol methyl ether, ethylene glycol ethyl ether, ethylene glycol-n-propyl ether, ethylene glycol-i-propyl ether, ethylene glycol-n-butyl ether (butyl cellosolve), ethylene glycol dimethyl ether, ethylene glycol ethyl ether acetate, diethylene glycol dimethyl ether, diethylene glycol diethyl ether, diethylene glycol monomethyl ether, diethylene glycol monoethyl ether, diethylene glycol monomethyl ether acetate, diethylene glycol monoethyl ether acetate, diisobutyl ketone, isoamyl propionate, isoamyl isobutyrate, diisopentyl ether, ethylene carbonate, and propylene carbonate. These may be used singly or as a mixture of two or more kinds thereof.

The solid content concentration (a ratio of a total mass of components other than the solvent of the alignment film composition in a total mass of the alignment film composition) in the alignment film composition used in the invention is appropriately selected in consideration of viscosity, volatility, and the like, and is preferably in the range of 1 to 10 mass %. That is, the alignment film composition used in the invention is applied to a surface of the plastic substrate as will be described later and heated at 40° C. to 150° C., such that a coating film which is an alignment film or a coating film to be an alignment film is formed. In this case, in a case where the solid content concentration is less than 1 mass %, the thickness of the coating film is excessively reduced, and thus a good alignment film is not easily obtained. In a case where the solid content concentration is greater than 10 mass %, the thickness of the coating film is excessively increased, and thus a good alignment film is not easily obtained. In addition, there is a tendency that the viscosity of the alignment film increases and coatability is thus reduced.

A particularly preferable solid content concentration range varies in accordance with use of the alignment film composition or a method which is used in the application of the alignment film composition to the plastic substrate. For example, in a case where a printing method is used, it is particularly preferable that the solid content concentration is set in the range of 3 to 9 mass % and the solution viscosity is thus set in the range of 12 to 50 mPa·s. In a case where an ink jet method is used, it is particularly preferable that the solid content concentration is set in the range of 1 to 5 mass % and the solution viscosity is thus set in the range of 3 to 15 mPa·s. In a case where the alignment film composition according to the invention is dried, the temperature is preferably 60° C. to 140° C., and particularly preferably 80° C. to 130° C.

[Plastic Substrate]

The liquid crystal cell according to the invention does not use a glass substrate of the related art, but uses a plastic substrate in order to realize three-dimensional formability with a high degree of freedom.

In a case where the liquid crystal cell is three-dimensionally formed, a thermoplastic resin is preferably used as the plastic substrate since local dimensional changes occur such as stretching or contraction. As the thermoplastic resin, a polymer resin is preferable which is excellent in optical transparency, mechanical strength, heat stability, and the like.

Examples of the polymer included in the plastic substrate include polycarbonate-based polymers; polyester-based polymers such as polyethylene terephthalate (PET); acryl-based polymers such as polymethylmethacrylate (PMMA); and styrene-based polymers such as polystyrene and acrylonitrile-styrene copolymers (AS resin).

Examples of the polymer further include polyolefins such as polyethylene and polypropylene; polyolefin-based polymers such as norbornene-based resins and ethylene-propylene copolymers; amide-based polymers such as vinyl chloride-based polymers, nylon, and aromatic polyamides; imide-based polymers; sulfone-based polymers; polyether sulfone-based polymers; polyetheretherketone-based polymers; polyphenylene sulfide-based polymers; vinylidene chloride-based polymers; vinyl alcohol-based polymers; vinyl butyral-based polymers; acrylate-based polymers; polyoxymethylene-based polymers; epoxy-based polymers; cellulose-based polymers represented by triacetylcellulose; and copolymers copolymerized in units of monomers of the above polymers.

Examples of the plastic substrate also include a substrate formed by mixing two or more kinds of the polymers mentioned above as examples.

{Heat-Shrinkable Film}

In the production of a three-dimensional structural liquid crystal cell to be described later, in a case where forming is performed using the contraction of the liquid crystal cell, it is preferable that at least one of the at least two plastic substrates is a heat-shrinkable film, and it is more preferable that all the plastic substrates are heat-shrinkable films.

By shrinking the heat-shrinkable film, it is possible to realize three-dimensional formability with a high degree of freedom.

Means for shrinkage is not particularly limited, and examples thereof include shrinkage by stretching during the course of film formation. The effect caused by shrinkage of the film itself, shrinkage by residual distortion during film formation, shrinkage by a residual solvent, or the like can also be used.

<Heat Shrinkage Rate>

The heat shrinkage rate of the heat-shrinkable film used in the invention is 5% to 75%, preferably 7% to 60%, and more preferably 10% to 45%.

In the heat-shrinkable film used in the invention, the maximum heat shrinkage rate in an in-plane direction of the heat-shrinkable film is preferably 5% to 75%, more preferably 7% to 60%, and even more preferably 10% to 45%. In a case where stretching is performed as means for shrinkage, the in-plane direction in which the maximum heat shrinkage rate is shown coincides with a stretching direction.

In the heat-shrinkable film used in the invention, the heat shrinkage rate in a direction perpendicular to the in-plane direction in which the maximum heat shrinkage rate is shown is preferably 0% to 5%, and more preferably 0% to 3%.

A measurement sample is cut every 5° in the measurement of a heat shrinkage rate under conditions to be described later, heat shrinkage rates in an in-plane direction of all of the measurement samples are measured, and the in-plane direction in which the maximum heat shrinkage rate is shown is specified by a direction in which the maximum measurement value is shown.

In the invention, the heat shrinkage rate is a value measured under the following conditions.

To measure the heat shrinkage rate, a measurement sample having a length of 15 cm and a width of 3 cm with a long side in a measurement direction was cut, and 1 cm-squares were stamped on one film surface in order to measure the film length. A point separated from an upper part of a long side of 15 cm by 3 cm on a central line having a width of 3 cm was set as A, a point separated from a lower part of the long side by 2 cm was set as B, and a distance AB of 10 cm between the points was defined as an initial film length L₀. The film was clipped up to 1 cm away from the upper part of the long side with a clip having a width of 5 cm and hung from the ceiling of an oven heated to a glass transition temperature (Tg) of the film. In this case, the film was put into a tension-free state while not being weighted. The entire film was sufficiently and uniformly heated, and after 5 minutes, the film was taken out of the oven for each clip to measure a length L between the points A and B after the heat shrinkage, and a heat shrinkage rate was obtained through Expression 2.

Heat Shrinkage Rate (%)=100×(L₀−L)/L₀ (Expression 2)

<Glass Transition Temperature (Tg)>

The Tg of the heat-shrinkable film used in the invention can be measured using a differential scanning calorimeter.

Specifically, the measurement was performed using a differential scanning calorimeter DSC7000X manufactured by Hitachi High-Tech Science Corporation under conditions of a nitrogen atmosphere and a heating rate of 20° C./min, and a temperature at a point where tangents of respective DSC curves at a peak top temperature of a time differential DSC curve (DDSC curve) of the obtained result and at a temperature of (peak top temperature−20° C.) intersected was set as a Tg.

<Stretching Step>

The heat-shrinkable film used in the invention may be an unstretched thermoplastic resin film, but preferably a stretched thermoplastic resin film.

The stretching ratio is not particularly limited, but preferably greater than 0% and not greater than 300%. The stretching ratio is more preferably greater than 0% and not greater than 200%, and even more preferably greater than 0% and not greater than 100% from the practical stretching step.

The stretching may be performed in a film transport direction (longitudinal direction), in a direction perpendicular to the film transport direction (transverse direction), or in both of the directions.

The stretching temperature is preferably around the glass transition temperature Tg of the heat-shrinkable film to be used, more preferably Tg±0° C. to 50° C., even more preferably Tg±0° C. to 40° C., and particularly preferably Tg±0° C. to 30° C.

In the invention, the film may be biaxially stretched simultaneously or sequentially in the stretching step. In a case of sequential biaxial stretching, the stretching temperature may be changed for each stretching in each direction.

In a case of sequential biaxial stretching, it is preferable that first, the film is stretched in a direction parallel to the film transport direction, and then stretched in a direction perpendicular to the film transport direction. The stretching temperature range in which the sequential stretching is performed is more preferably the same as a stretching temperature range in which the simultaneous biaxial stretching is performed.

<Three-Dimensional Structural Liquid Crystal Cell>

The three-dimensional structural liquid crystal cell according to the invention is formed by changing dimensions of the liquid crystal cell according to the invention by ±5% to 75%.

Here, the dimensional change is a ratio of a difference before and after the change in a case where a dimension before the change is 100. For example, a dimensional change by 30% is a state in which the dimension after change is 130 relative to the dimension (100) before change, and the difference before and after the change is 30.

In addition, the three-dimensional structural liquid crystal cell according to the invention can be produced by three-dimensionally forming the liquid crystal cell according to the invention.

Three-dimensional forming is performed by, for example, rolling the liquid crystal cell according to the invention into a tubular shape, and by then contracting the liquid crystal. For example, by shrinking and forming according to a body shaped like a beverage bottle, a display device or a dimming device can be installed on the bottle, or a display device covering the vicinity of the cylindrical structure can be realized.

Otherwise, under the environment at around the Tg of the plastic substrate, forming can be performed by pressing into a shape corresponding to the mold.

### EXAMPLES

Hereinafter, the invention will be described in detail with reference to examples. The materials, the reagents, the amounts of materials, the proportions thereof, the conditions, the operations, and the like which will be shown in the following examples can be appropriately modified within a range not departing from the gist of the invention. Accordingly, the scope of the invention is not limited to the following examples.

<<Transmittance>>

In the invention, the transmittance is an average of values obtained by ten times of measurement at a wavelength of 400 to 750 nm using a spectrophotometer (UV3150, manufactured by Shimadzu Corporation).

<<Sheet Resistance Value>>

In the invention, the sheet resistance value is a value which is measured using a resistivity meter (LORESTA GP MCP-T600, manufactured by Mitsubishi Chemical Corporation) and an ESP probe (MCP-TP08P) under the environment of a relative humidity of 55% at 25° C.

However, in a case where the sheet resistance cannot be directly measured using the above-described method due to the lamination of a separate layer (insulating layer or the like) on the measurement target, the sheet resistance value is a value which is obtained using a non-contact sheet resistance meter such as an eddy current-type resistance meter and calibrated by the above-described method.

<<Haze>>

In the invention, the haze is a value which is measured under the following conditions based on JIS K-7136 (2000).

[Device Name] Haze Meter NDH2000 (manufactured by Nippon Denshoku Industries Co., Ltd.)

[Sample Size] 50 mm×50 mm

[Measurement Environment] Relative Humidity of 55% at 25° C.

### Example 1

<Production of Plastic Substrate>

A polycarbonate (PC-2151, thickness: 250 μm) manufactured by TEIJIN LIMITED was clipped with a clip and stretched at a stretching ratio of 20% in a film transport direction (machine direction: MD) and at a stretching ratio of 100% in a direction perpendicular to the MD (transverse direction: TD) using a tenter under conditions of biaxial stretching with a fixed end at a stretching temperature of 155° C. to produce a plastic substrate. In this case, the glass transition temperature (Tg) was 150° C., and the heat shrinkage rate in the TD measured through the above-described method was 40%.

The in-plane direction in which the maximum heat shrinkage rate was shown substantially coincided with the TD, and the heat shrinkage rate in the MD perpendicular thereto was 6%.

<Production of Conductive Layer>

On a surface of the plastic substrate produced as described above, a conductive layer was produced using a Ag nanowire through the method described in Example 1 in US2013/0341074A to produce a laminate of the plastic substrate formed of the stretched polycarbonate and the conductive layer formed of the Ag nanowire. The thickness of the conductive layer was 15 μm.

After the laminate produced as described above was cut into a 10 cm square shape, the transmittance, the sheet resistance value, and the haze were measured. The transmittance was 90%, the sheet resistance value was 40Ω/□, and the haze was 0.65.

<Production of Polymer Layer>

A polymer layer coating liquid was produced with the following prescription.

Prescription of Polymer Layer Coating Liquid

| BLEMMER GLM | 100 | parts by mass |
|---|---|---|
| (manufactured by NOF Corporation) | | |
| Photopolymerization Initiator | 3 | parts by mass |
| (IRGACURE 819 (manufactured by BASF SE)) | | |
| The following Surfactant A | 0.5 | parts by mass |

| | |
|---|---|
| Ethanol | including a solid |
| | content of 30% |

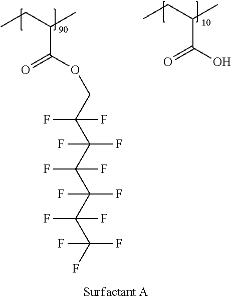

The produced polymer layer coating liquid was applied to the conductive layer using a bar coater #3 in such an amount that the film thickness was 1.3 μm, and was heated and dried for 1 minute such that the film surface temperature was 50° C. Then, the resulting material was irradiated with 500 mJ/cm² of ultraviolet rays by an ultraviolet irradiation device under a nitrogen purge with an oxygen concentration of 100 ppm or less to cause a polymerization reaction, and thus a polymer layer was produced. The irradiation dose was measured at a wavelength of 365 nm. A mercury lamp was used.

The absorption maximum wavelength of BLEMMER GLM (manufactured by NOF Corporation) was 210 nm, and the SP value was 26. The polymer layer had a thickness of 1.5 μm.

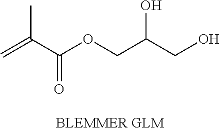

<Production of Alignment Film>

An alignment film coating liquid was produced with the following prescription.

Prescription of Alignment Film Coating Liquid

| | |
|---|---|
| The following Alignment Film Material B | 100 parts by mass |
| Acetone | including a solid content of 4% |

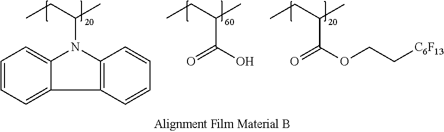

The produced alignment film coating liquid was applied to the polymer layer using a bar coater #1.6 in such an amount that the film thickness was 90 nm. Then, the resulting material was heated and dried for 1 minute such that the film surface temperature was 50° C., and an alignment film was produced. The alignment film had a thickness of 100 nm.

<Production of Spacer Layer>

A spacer layer dispersion was produced with the following prescription.

Prescription of Spacer Layer Dispersion

| | |
|---|---|
| BEAD SPACER SP-208 (manufactured by | 100 parts by mass |
| SEKISUI CHEMICAL CO., LTD.) | |
| Methyl Isobutyl Ketone | including a solid |
| | content of 0.2% |

The produced spacer layer dispersion was applied to the alignment film using an applicator with a clearance set to 100 μm. Then, the resulting material was heated and dried for 1 minute such that the film surface temperature was 60° C., and a spacer layer was produced.

<Production of Liquid Crystal Cell>

A liquid crystal layer composition was produced with the following prescription.

Liquid Crystal Layer Composition

| | |
|---|---|
| ZLI2806 (manufactured by | 100 parts by mass |
| Merck KGaA) | |
| Cholesteric Nonanate (manufactured by | 1.74 parts by mass |
| Tokyo Chemical Industry Co., Ltd.) | |
| G-472 (manufactured by | 3.00 parts by mass |
| Hayashibara Co., Ltd.) | |

A UV sealing agent TB3026 (manufactured by ThreeBond Holdings Co., Ltd.) was applied to an end portion of the alignment film having the spacer layer disposed thereon in accordance with the shape of the laminate produced as described above, and the produced liquid crystal layer composition was applied dropwise to the center of the alignment film and sandwiched between the above laminate and a laminate formed to include an alignment film in the same manner. The liquid crystal layer composition was uniformly distributed with a roller, and a liquid crystal layer was produced. Liquid crystals in the produced liquid crystal cell were uniformly aligned vertically, and the liquid crystal cell showed a light blue color. The average transmittance at 400 to 750 nm was 75%.

<Production of Three-Dimensional Structural Liquid Crystal Cell>

The produced liquid crystal cell was fitted in and fixed to a separately prepared die, heated for 30 minutes at 155° C., and subjected to shrinkage forming to produce a three-dimensional structural liquid crystal cell. In this case, the dimensional change was −10%. The shape of the produced three-dimensional structural liquid crystal cell was along the die, and no whitening or cracking occurred. The average transmittance at 400 to 750 nm was maintained to 75%.

<Confirmation of Driving>

The conductive layer of the three-dimensional structural liquid crystal cell produced as described above was connected to an electrode and a voltage of 3 V was applied thereto. Coloring and discoloration were reversibly shown according to the application/no application, and it was confirmed that it was possible to drive the liquid crystal cell.

### Example 2

<Production of Liquid Crystal Cell>

A liquid crystal cell was produced in the same manner as in Example 1, except that BLEMMER GLM (manufactured by NOF Corporation) of the polymer layer was changed to the following BLEMMER AE400 (manufactured by NOF Corporation). The absorption maximum wavelength of BLEMMER AE400 was 210 nm, and the SP value was 25. The polymer layer had a thickness of 1.5 μm.

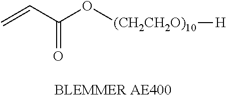

<Production of Three-Dimensional Structural Liquid Crystal Cell>

The produced liquid crystal cell was fitted in and fixed to the die used in Example 1, heated for 30 minutes at 155° C., and subjected to shrinkage forming to produce a three-dimensional structural liquid crystal cell. In this case, the dimensional change was −10%. The shape of the produced three-dimensional structural liquid crystal cell was along the die, and no whitening or cracking occurred. The average transmittance at 400 to 750 nm was maintained to 75%.

<Confirmation of Driving>

The conductive layer of the three-dimensional structural liquid crystal cell produced was connected to an electrode and a voltage of 3 V was applied thereto. Coloring and discoloration were reversibly shown according to the application/no application, and it was confirmed that it was possible to drive the liquid crystal cell.

### Example 3

<Production of Liquid Crystal Cell>

A liquid crystal cell was produced in the same manner as in Example 1, except that BLEMMER GLM (manufactured by NOF Corporation) of the polymer layer was changed to an acrylamide. The absorption maximum wavelength of the acrylamide was 203 nm, and the SP value was 27. The polymer layer had a thickness of 1.5 μm.

<Production of Three-Dimensional Structural Liquid Crystal Cell>

The produced liquid crystal cell was fitted in and fixed to the die used in Example 1, heated for 30 minutes at 155° C., and subjected to shrinkage forming to produce a three-dimensional structural liquid crystal cell. In this case, the dimensional change was −10%. The shape of the produced three-dimensional structural liquid crystal cell was along the die, and no whitening or cracking occurred. The average transmittance at 400 to 750 nm was maintained to 75%.

<Confirmation of Driving>

The conductive layer of the three-dimensional structural liquid crystal cell produced was connected to an electrode and a voltage of 3 V was applied thereto. Coloring and discoloration were reversibly shown according to the application/no application, and it was confirmed that it was possible to drive the liquid crystal cell.

### Example 4

<Production of Liquid Crystal Cell>

A liquid crystal cell was produced in the same manner as in Example 1, except that BLEMMER GLM (manufactured by NOF Corporation) of the polymer layer was changed to the following BLEMMER PME4000 (manufactured by NOF Corporation). The film absorption maximum of BLEMMER PME4000 was 210 nm, and the SP value was 21. The polymer layer had a thickness of 1.5 μm.

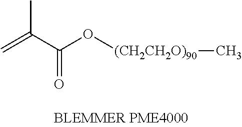

<Production of Three-Dimensional Structural Liquid Crystal Cell>

The produced liquid crystal cell was fitted in and fixed to the die used in Example 1, heated for 30 minutes at 155° C., and subjected to shrinkage forming to produce a three-dimensional structural liquid crystal cell. In this case, the dimensional change was −10%. The shape of the produced three-dimensional structural liquid crystal cell was along the die, slight whitening was observed, and the vertical alignment of liquid crystals was found to be disturbed. Therefore, the average transmittance at 400 to 750 nm was reduced to 60%.

<Confirmation of Driving>

The conductive layer of the three-dimensional structural liquid crystal cell produced was connected to an electrode and a voltage of 3 V was applied thereto. Coloring and discoloration were reversibly shown according to the application/no application, and it was confirmed that it was possible to drive the liquid crystal cell.

### Example 5

<Production of Liquid Crystal Cell>

A liquid crystal cell was produced in the same manner as in Example 1, except that BLEMMER GLM (manufactured by NOF Corporation) of the polymer layer was changed to the following BLEMMER QA (manufactured by NOF Corporation). The film absorption maximum of BLEMMER QA was 215 nm, and the SP value was 21. The polymer layer had a thickness of 1.5 μm.

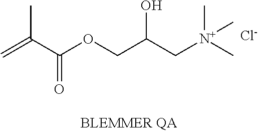

<Production of Three-Dimensional Structural Liquid Crystal Cell>

The produced liquid crystal cell was fitted in and fixed to the die used in Example 1, heated for 30 minutes at 155° C., and subjected to shrinkage forming to produce a three-dimensional structural liquid crystal cell. In this case, the dimensional change was −10%. The shape of the produced three-dimensional structural liquid crystal cell was along the die, slight whitening was observed, and the vertical alignment of liquid crystals was found to be disturbed. Therefore, the average transmittance at 400 to 750 nm was reduced to 50%.

<Confirmation of Driving>

The conductive layer of the three-dimensional structural liquid crystal cell produced was connected to an electrode and a voltage of 3 V was applied thereto. The driving performance of coloring and discoloration was unstable due to the influence of the ionic polymer layer.

### Example 6

<Production of Liquid Crystal Cell>

A liquid crystal cell of Example 6 using a carbon nanobud as a conductive layer was produced in the same manner as in Example 1, except that in place of the Ag nanowire, a carbon nanobud film was formed using a direct dry printing (DDP) method described in SID 2015 DIGEST, p. 1012 on the surface of the stretched PET film. The conductive layer had a thickness of 100 nm. Liquid crystals in the produced liquid crystal cell were uniformly aligned vertically, and the liquid crystal cell showed a light blue color. The average transmittance at 400 to 750 nm was 70%.

<Production of Three-Dimensional Structural Liquid Crystal Cell>

The produced liquid crystal cell was fitted in and fixed to the die used in Example 1, heated for 30 minutes at 155° C., and subjected to shrinkage forming to produce a three-dimensional structural liquid crystal cell. In this case, the dimensional change was −10%. The shape of the produced three-dimensional structural liquid crystal cell was along the die, and no whitening or cracking occurred. The average transmittance at 400 to 750 nm was maintained to 70%.

<Confirmation of Driving>

The conductive layer of the three-dimensional structural liquid crystal cell produced was connected to an electrode and a voltage of 3 V was applied thereto. Coloring and discoloration were reversibly shown according to the application/no application, and it was confirmed that it was possible to drive the liquid crystal cell.

### Comparative Example 1

<Production of Liquid Crystal Cell>

A liquid crystal cell was produced in the same manner as in Example 1, except that no polymer layer was installed.

<Production of Three-Dimensional Structural Liquid Crystal Cell>

The produced liquid crystal cell was fitted in and fixed to the die used in Example 1, heated for 30 minutes at 155° C., and subjected to shrinkage forming to produce a three-dimensional structural liquid crystal cell. In this case, the dimensional change was −10%. The shape of the produced three-dimensional structural liquid crystal cell was along the die, but the support was impregnated with the liquid crystal compound and noticeable whitening occurred. In addition, the vertical alignment of liquid crystals was not uniform. Therefore, the average transmittance at 400 to 750 nm was reduced to 20%.

<Confirmation of Driving>

The conductive layer of the three-dimensional structural liquid crystal cell produced was connected to an electrode and a voltage of 3 V was applied thereto. Whitening was shown due to the liquid crystal compound permeating into the support.

### Comparative Example 2

A liquid crystal cell was produced in the same manner as in Example 1, except that BLEMMER GLM (manufactured by NOF Corporation) of the polymer layer was changed to DPHA (manufactured by Nippon Kayaku Co., Ltd., mixture of dipentaerythritol pentaacrylate and dipentaerythritol hexaacrylate). The film absorption maximum of DPHA was 210 nm, and the SP value was 21. The polymer layer had a thickness of 1.5 μm.

<Production of Three-Dimensional Structural Liquid Crystal Cell>

The produced liquid crystal cell was fitted in and fixed to the die used in Example 1, heated for 30 minutes at 155° C., and subjected to shrinkage forming to produce a three-dimensional structural liquid crystal cell. In this case, the dimensional change was −10%. The shape of the produced three-dimensional structural liquid crystal cell was along the die, but noticeable whitening and cracking occurred. In addition, the vertical alignment of liquid crystals was not uniform. Therefore, it was not possible to measure the average transmittance at 400 to 750 nm.

<Confirmation of Driving>

The conductive layer of the three-dimensional structural liquid crystal cell produced was connected to an electrode and a voltage of 3 V was applied thereto. Whitening was shown due to the liquid crystal compound permeating into the support.

### Comparative Example 3

<Production of Liquid Crystal Cell>

A liquid crystal cell was produced in the same manner as in Example 1, except that BLEMMER GLM (manufactured by NOF Corporation) of the polymer layer was changed to the following SP327 (manufactured by OSAKA ORGANIC CHEMICAL INDUSTRY LTD.). The film absorption maximum of SP327 was 210 nm, and the SP value was 20. The polymer layer had a thickness of 1.5 μm.

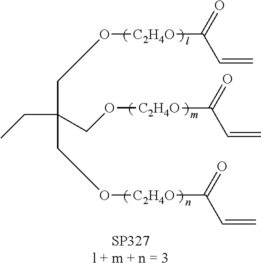

<Production of Three-Dimensional Structural Liquid Crystal Cell>

The produced liquid crystal cell was fitted in and fixed to the die used in Example 1, heated for 30 minutes at 155° C., and subjected to shrinkage forming to produce a three-dimensional structural liquid crystal cell. In this case, the dimensional change was −10%. The shape of the produced three-dimensional structural liquid crystal cell was along the die, and the polymer layer was formed by polymerizing an acrylate having a nonionic hydrophilic group (polyethyleneoxy group). However, noticeable whitening and cracking occurred since the acrylate is trifunctional. In addition, the vertical alignment of liquid crystals was not uniform. Therefore, it was not possible to measure the average transmittance at 400 to 750 nm.

<Confirmation of Driving>

The conductive layer of the three-dimensional structural liquid crystal cell produced was connected to an electrode and a voltage of 3 V was applied thereto. The alignment film function was damaged due to cracking and driving was impossible.

### Comparative Example 4

<Production of Liquid Crystal Cell>

A liquid crystal cell was produced in the same manner as in Example 1, except that BLEMMER GLM (manufactured by NOF Corporation) of the polymer layer was changed to the following lauryl acrylate (manufactured by OSAKA ORGANIC CHEMICAL INDUSTRY LTD.). The film absorption maximum of the lauryl acrylate was 210 nm, and the SP value was 18. The polymer layer had a thickness of 1.5 μm.

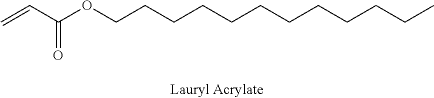 [SMILES: C=CC(=O)OCCCCCCCCCCCC]

<Production of Three-Dimensional Structural Liquid Crystal Cell>

The produced liquid crystal cell was fitted in and fixed to the die used in Example 1, heated for 30 minutes at 155° C., and subjected to shrinkage forming to produce a three-dimensional structural liquid crystal cell. In this case, the dimensional change was −10%. The shape of the produced three-dimensional structural liquid crystal cell was along the die, and since the polymer layer was formed by polymerizing a monofunctional acrylate, cracking did not occur. However, since the acrylate had no hydrophilic group and was hydrophobic, the barrier performance of the liquid crystals was insufficient and a whitening phenomenon occurred. In addition, the vertical alignment of liquid crystals was not uniform. Therefore, it was not possible to measure the average transmittance at 400 to 750 nm.

<Confirmation of Driving>

The conductive layer of the three-dimensional structural liquid crystal cell produced was connected to an electrode and a voltage of 3 V was applied thereto. Whitening was shown due to the liquid crystal compound permeating into the support.

The following Table 1 shows the results of the above-described examples and comparative examples.

TABLE 1

| | | | Polymer Layer | | | | | |
|---|---|---|---|---|---|---|---|---|
| | | | | | | | Absorption | |
| | | | | Numer of | | | Maximum | |
| | Plastic | Conductive | Hydrophilic | Functional | Hydrophilic | | Wavelength | |
| | Substrate | Layer | Monomer | Groups | Group | Ionicity | (nm) | SP Value |
| Example 1 | Polycarbonate | Ag | BLEMMER | Monofunctional | Hydroxyl Group | Nonionic | 210 | 26 |
| | | Nanowire | GLM | | | | | |
| Example 2 | Polycarbonate | Ag | BLEMMER | Monofunctional | Polyethylene | Nonionic | 210 | 25 |
| | | Nanowire | AE400 | | Glycol Group | | | |
| Example 3 | Polycarbonate | Ag | Acrylamide | Monofunctional | Amino Group | Nonionic | 203 | 27 |
| | | Nanowire | | | | | | |
| Example 4 | Polycarbonate | Ag | BLEMMER | Monofunctional | Polyethylene | Nonionic | 210 | 21 |
| | | Nanowire | PME4000 | | Glycol Group | | | |
| Example 5 | Polycarbonate | Ag | BLEMMER | Monofunctional | Quaternary | Cationic | 215 | 21 |
| | | Nanowire | QA | | Ammonium | | | |
| | | | | | group | | | |
| Example 6 | Polycarbonate | Carbon | BLEMMER | Monofunctional | Hydroxyl Group | Nonionic | 210 | 26 |
| | | Nanobud | GLM | | | | | |
| Comparative | Polycarbonate | Ag | None | — | — | — | — | — |
| Example 1 | | Nanowire | | | | | | |
| Comparative | Polycarbonate | Ag | DPHA | Pentafunctional/ | None | Nonionic | 210 | 21 |
| Example 2 | | Nanowire | | Hexafunctional | | | | |
| Comparative | Polycarbonate | Ag | SP327 | Trifunctional | Polyethyleneoxy | Nonionic | 210 | 20 |
| Example 3 | | Nanowire | | | Group | | | |
| Comparative | Polycarbonate | Ag | Lauryl Acrylate | Monofunctional | None | Nonionic | 210 | 18 |
| Example 4 | | Nanowire | | | | | | |

| | Before Forming | After Forming | | | |
|---|---|---|---|---|---|
| | Transmittance (%) | Whitening | Cracking | Transmittance (%) | Driving |
| Example 1 | 75 | None | None | 75 | Possible |
| Example 2 | 75 | None | None | 75 | Possible |
| Example 3 | 75 | None | None | 75 | Possible |
| Example 4 | 75 | Slight | None | 60 | Possible |
| | | Whitening | | | |
| Example 5 | 75 | Slight | None | 50 | Unstable |
| | | Whitening | | | |
| Example 6 | 70 | None | None | 70 | Possible |
| Comparative | 80 | Noticeable | None | 20 | Impossible |
| Example 1 | | Whitening | | | |
| Comparative | 75 | Noticeable | Occurred | Unmeasurable | Impossible |
| Example 2 | | Whitening | | | |
| Comparative | 75 | Whitening | Occurred | Unmeasurable | Impossible |
| Example 3 | | | | | |
| Comparative | 75 | Whitening | None | Unmeasurable | Impossible |
| Example 4 | | | | | |

### EXPLANATION OF REFERENCES

1, 4: plastic substrate
2: polymer layer
3: liquid crystal layer
10: liquid crystal cell

What is claimed is:

1. A liquid crystal cell comprising:
at least two plastic substrates; and
a liquid crystal layer;
wherein at least one plastic substrate is a heat-shrinkable film satisfying a heat shrinkage rate of 5% to 75%,
a polymer layer which is obtained by polymerizing a composition including at least one kind of monofunctional monomer having a hydrophilic group and selected from the group consisting of a monofunctional acrylate and a monofunctional methacrylate between at least one plastic substrate and the liquid crystal layer is further included, and
an absorption maximum wavelength of the monofunctional monomer is 190 to 250 nm.

2. The liquid crystal cell according to claim 1,
wherein the composition including a monofunctional monomer is a composition exhibiting one or both of a thermosetting property and ultraviolet curability.

3. The liquid crystal cell according to claim 1,
wherein the monofunctional monomer is a monofunctional monomer having two or more hydrophilic groups.

4. The liquid crystal cell according to claim 2,
wherein the monofunctional monomer is a monofunctional monomer having two or more hydrophilic groups.

5. The liquid crystal cell according to claim 1,
wherein the hydrophilic group is a nonionic hydrophilic group.

6. The liquid crystal cell according to claim 2,
wherein the hydrophilic group is a nonionic hydrophilic group.

7. The liquid crystal cell according to claim 5,
wherein the nonionic hydrophilic group is at least one kind of hydrophilic group selected from the group consisting of a hydroxyl group, a substituted or unsubstituted amino group, and a polyethylene glycol group.

8. The liquid crystal cell according to claim 1,
wherein the monofunctional monomer is a monofunctional monomer having two or more hydroxyl groups as a hydrophilic group.

9. The liquid crystal cell according to claim 2,
wherein the monofunctional monomer is a monofunctional monomer having two or more hydroxyl groups as a hydrophilic group.

10. The liquid crystal cell according to claim 1,
wherein the monofunctional monomer is a monofunctional monomer having both of a hydroxyl group and a substituted or unsubstituted amino group as a hydrophilic group.

11. The liquid crystal cell according to claim 2,
wherein the monofunctional monomer is a monofunctional monomer having both of a hydroxyl group and a substituted or unsubstituted amino group as a hydrophilic group.

12. The liquid crystal cell according to claim 1,
wherein the monofunctional monomer has an SP value of 22 to 40.

13. The liquid crystal cell according to claim 2,
wherein the monofunctional monomer has an SP value of 22 to 40.

14. The liquid crystal cell according to claim 1,
wherein all the plastic substrates are heat-shrinkable films satisfying a heat shrinkage rate of 5% to 75%.

15. The liquid crystal cell according to claim 2,
wherein all the plastic substrates are heat-shrinkable films satisfying a heat shrinkage rate of 5% to 75%.

16. The liquid crystal cell according to claim 1,
wherein at least one plastic substrate is a thermoplastic resin film stretched by greater than 0% and not greater than 300%.

17. The liquid crystal cell according to claim 2,
wherein at least one plastic substrate is a thermoplastic resin film stretched by greater than 0% and not greater than 300%.

18. A three-dimensional structural liquid crystal cell which is formed by changing dimensions of the liquid crystal cell according to claim 1 by ±5% to 75%.

19. A three-dimensional structural liquid crystal cell which is formed by changing dimensions of the liquid crystal cell according to claim 2 by ±5% to 75%.

20. A three-dimensional structural liquid crystal cell which is formed by changing dimensions of the liquid crystal cell according to claim 3 by ±5% to 75%.
